(19) United States
(12) Patent Application Publication
(10) Pub. No.: US 2026/0233566 A1
(43) Pub. Date: Aug. 13, 2026

(54) Anti-Theft Device for Trailer Hitches

(71) Applicant: Bryan Witchey, Jupiter, FL (US)

(72) Inventor: Bryan Witchey, Jupiter, FL (US)

(21) Appl. No.: 19/050,000

(22) Filed: Feb. 10, 2025

(51) Int. Cl. B60D 1/60; E05B 83/00

(52) U.S. Cl. CPC B60D 1/60; E05B 83/00

(57) ABSTRACT

In one embodiment, an anti-theft device comprises a C-shaped member, a handle, a lock mechanism, and a lock housing. The C-shaped member comprises an upper portion and a lower portion. The upper portion defines an internal side that defines a channel. The lower portion defines a female aperture and a through-hole. The handle comprises a shaft and a ball. The ball is located atop of the shaft. The shaft comprises a longitudinal male member. One end of the longitudinal male member is attached to and extends away from the shaft. The other end of the longitudinal male member is sized to fit inside the female aperture. The longitudinal male member defines a notch. The lock mechanism is in operable communication with the notch via the through-hole. The lock housing is located at least partly around the lock mechanism.

### CROSS-REFERENCE TO RELATED APPLICATIONS

Not applicable.

### STATEMENT REGARDING FEDERALLY SPONSORED RESEARCH OR DEVELOPMENT

Not applicable.

### FIELD OF THE INVENTION

The invention relates to an anti-theft device to prevent the theft of trailers.

### BACKGROUND

The theft of trailers is a serious problem. The present invention is an anti-theft device for helping to prevent the theft of trailers.

### SUMMARY

In one non-limiting embodiment, an anti-theft device 20 comprises a C-shaped member 40, a handle 240, a lock mechanism 380, and a lock housing 440.

The C-shaped member 40 defines an upper portion 60 and a lower portion 80. The upper portion 60 defines an upper portion internal side 100, and an upper portion external side 110. The upper portion internal side 100 defines a channel 120. The lower portion 80 defines a lower portion internal side 140 and a lower portion external side 160. The lower portion internal side 140 defines a female blind hole 180. A through-hole 200 extends between the lower portion internal side 140 and the lower portion external side 160. The female blind hole 180 is located in a central portion 220 of the lower portion internal side 140.

The handle 240 comprises a shaft 260 and a ball 280. The ball 280 is located atop of the shaft 260. The shaft 260 comprises a longitudinal male member 300 extending away from the shaft 260. The longitudinal male member 300 defines a first opposite end 320 and a second opposite end 340. The first opposite end 320 is sized to fit inside the female blind hole 180. The second opposite end 340 is attached to the shaft 260. The longitudinal male member 300 defines a notch 360 proximate to the first opposite end 320.

The lock mechanism 380 is in operable communication with the notch 360 via the through-hole 200.

The lock housing 440 is located at least partly around the lock mechanism 380.

It should be understood that the lock mechanism 380 can vary; for example, the lock mechanism can be a barrel lock 385 or a combination lock 420.

### BRIEF DESCRIPTION OF THE DRAWINGS

FIG. 1A shows a perspective view of one embodiment of an anti-theft device according to the present invention.

FIG. 1B shows a perspective view of one embodiment of an anti-theft device according to the present invention.

FIG. 2 shows a perspective view of one embodiment of the anti-theft device according to the present invention.

FIGS. 3 and 4 show perspective views of one embodiment of the anti-theft device according to the present invention.

FIG. 5A shows an exploded view of one embodiment of the anti-theft device (minus the invention's handle) according to the present invention.

FIG. 5B shows an exploded view of one embodiment of the anti-theft device (minus the invention's handle) according to the present invention.

FIG. 6 shows a front end view of the anti-theft device (minus the invention's handle) according to the present invention.

FIG. 7A shows a rear end view of the anti-theft device (minus the invention's handle) according to the present invention.

FIG. 7B shows a rear end view of the anti-theft device (minus the invention's handle and showing a female through-hole 187) according to the present invention.

FIG. 8 shows a front side view of the anti-theft device (minus the invention's handle) according to the present invention.

FIG. 9A shows a part cross-section view of the anti-theft device (with a female blind hole 180 and including a barrel lock 385) as viewed from above according to the present invention.

FIG. 9B shows a part cross-section view of the anti-theft device (with a female through-hole 187 and including a barrel lock 385) as viewed from above according to the present invention.

FIG. 10 shows a front side view of a handle according to the present invention.

FIG. 11 shows a side view of the handle shown in FIG. 10 according to the present invention.

FIG. 12 shows a rear view of the handle shown in FIG. 10 according to the present invention.

FIGS. 13 and 14 show perspective views of the anti-theft device (fitted with a combination lock 420) according to the present invention.

FIG. 15 shows an exploded view of a spring-loaded combination lock according to the present invention.

FIG. 15A shows an exploded view of a spring-loaded combination lock according to the present invention.

FIG. 16 shows a front end view of the anti-theft device (minus the invention's handle) according to the present invention.

FIG. 17 shows a rear end view of the anti-theft device (minus the invention's handle) according to the present invention.

FIGS. 18A through 18D show environmental views of the anti-theft device according to the present invention.

FIG. 19 shows a perspective view of the anti-theft device (fitted with a barrel lock 385 and minus the invention's handle) according to the present invention.

FIG. 20 shows a perspective view of the anti-theft device (fitted with a combination lock and minus the invention's handle) according to the present invention.

FIG. 21A shows a part cross-section view of the present invention showing the combination lock 420 in an open unlocked state.

FIG. 21B shows a part cross-section view of the present invention showing the combination lock 420 in a closed locked state.

FIG. 22 shows a part cross-section view of the present invention showing for reference purposes the female through-hole 187.

FIG. 23 shows a longitudinal male member 300 with a first threaded portion 345 to engage a complementary second threaded portion 350 located in a shaft 260.

FIG. 24 shows a handle with an internal solid structure with respect to the shaft and ball.

FIG. 25 shows a handle with an internal hollow shaft but with a solid ball.

FIG. 26 shows a handle with a hollow shaft and a hollow ball.

FIGS. 27A and 27B are tables which provide a list of parts and serve as a useful point of reference.

Similar reference characters denote corresponding features consistently throughout the attached drawings.

### DETAILED DESCRIPTION OF THE INVENTION

It is to be understood that the terms “top”, “bottom”, “left”, “right”, “side”, “front”, “rear”, “upper”, “lower”, “below”, “from below”, “above”, “from above”, “vertical”, “horizontal”, “height”, “width”, “length”, “end” and the like are used herein merely to describe points of reference and do not limit the present invention to any specific orientation or configuration. It should also be understood that the claimed invention and parts may be of any size, shape or configuration suitable for operation of the invention and may be constructed of any suitable materials. Still further, any and all dimensions if shown in attached Figures are example dimensions. Dimensions (for example, length, width, height, and angle) can vary from those shown.

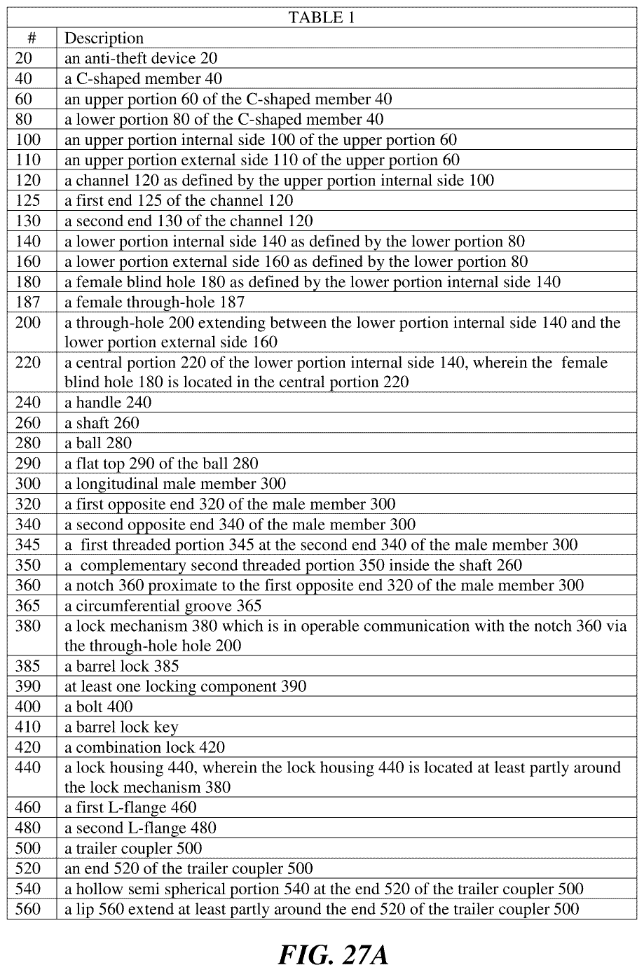

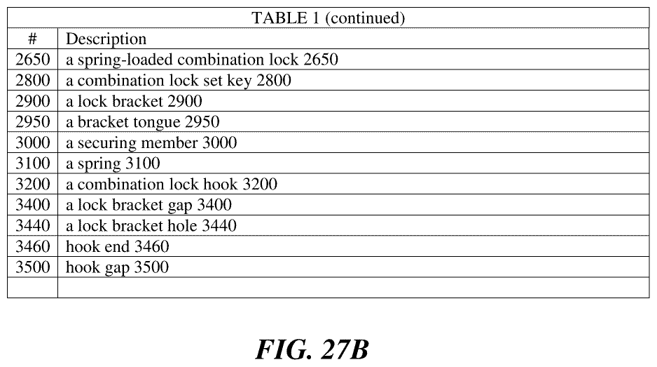

FIGS. 27A and 27B are tables which provide a list of parts and serve as a useful point of reference.

Referring to the Figures in general, an anti-theft device 20 comprises a C-shaped member 40, a handle 240, a lock mechanism 380, and a lock housing 440.

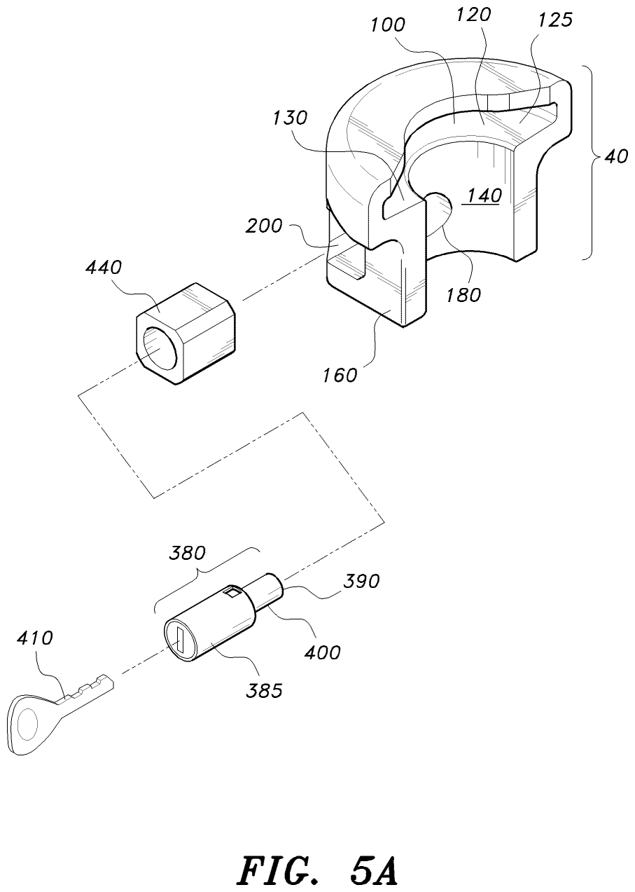

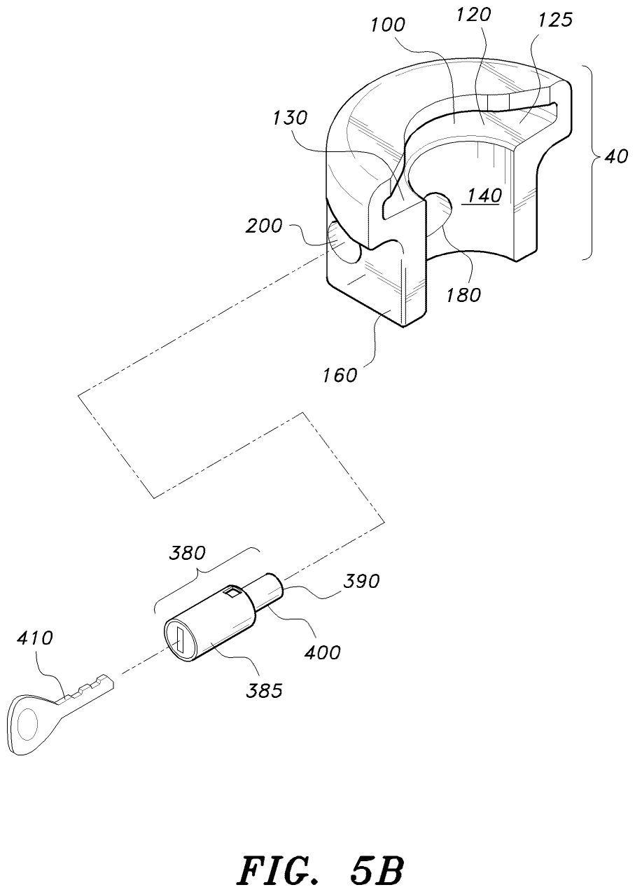

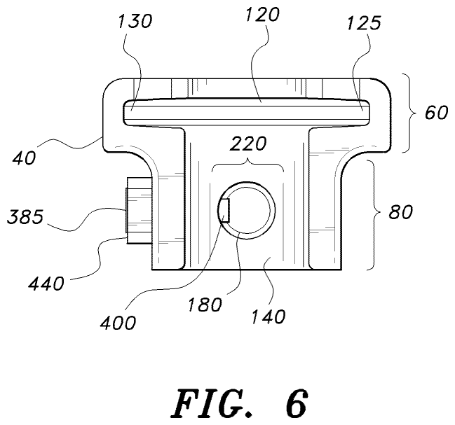

The C-shaped member 40 defines an upper portion 60 and a lower portion 80. The upper portion 60 defines an upper portion internal side 100, and an upper portion external side 110. The upper portion internal side 100 defines a channel 120. The lower portion 80 defines a lower portion internal side 140 and a lower portion external side 160. The lower portion internal side 140 defines a female blind hole 180. A through-hole 200 (shown in FIG. 5) extends between the lower portion internal side 140 and the lower portion external side 160. The female blind hole 180 is located in a central portion 220 (shown in FIG. 6) of the lower portion internal side 140.

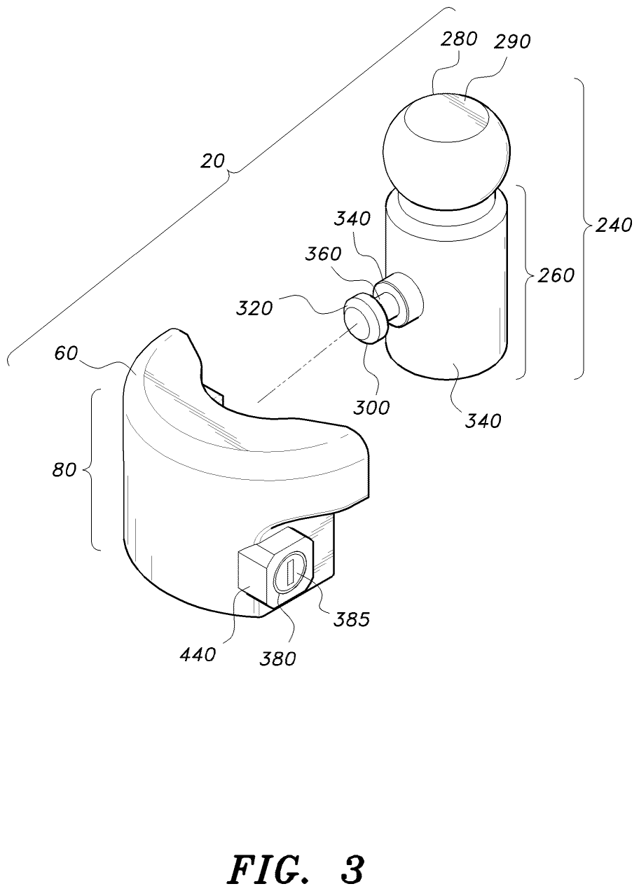

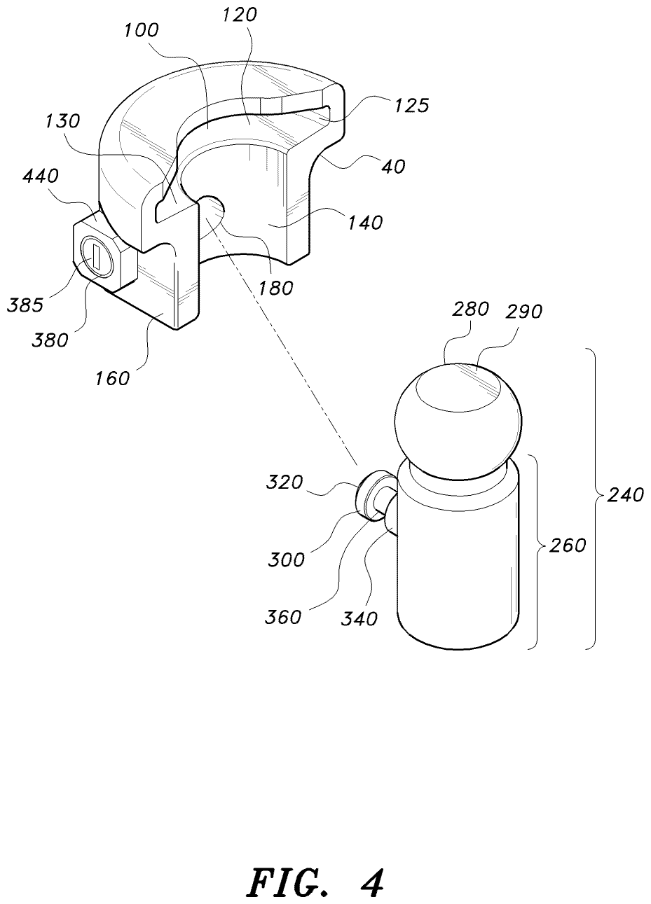

The handle 240 comprises a shaft 260 and a ball 280 (see, for example, FIGS. 3 and 4). The ball 280 is located atop of the shaft 260. The shaft 260 comprises a longitudinal male member 300 extending away from the shaft 260. The longitudinal male member 300 defines a first opposite end 320 and a second opposite end 340. The first opposite end 320 is sized to fit inside the female blind hole 180. The second opposite end 340 is attached to and extends from the shaft 260. The longitudinal male member 300 defines a notch 360.

The lock mechanism 380 is in operable communication with the notch 360 via the through-hole 200.

The lock housing 440 is located at least partly around the lock mechanism 380.

It should be understood that exact nature of the notch 360 can vary. In one non-limiting embodiment, the notch 360 defines a circumferential groove 365 as show, for example, in FIGS. 4 and 11.

In one non-limiting embodiment, the ball 280 defines a flat top 290 (see, for example, FIGS. 3, 4, and 12).

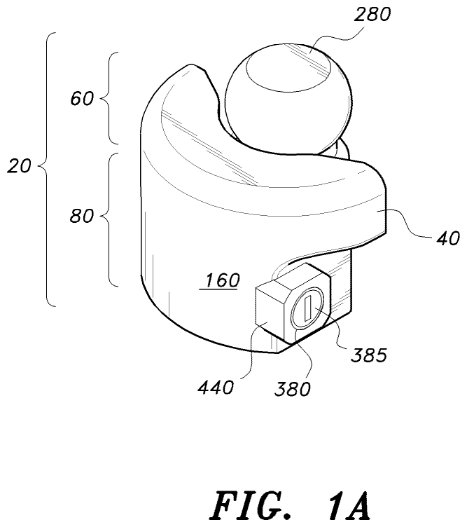

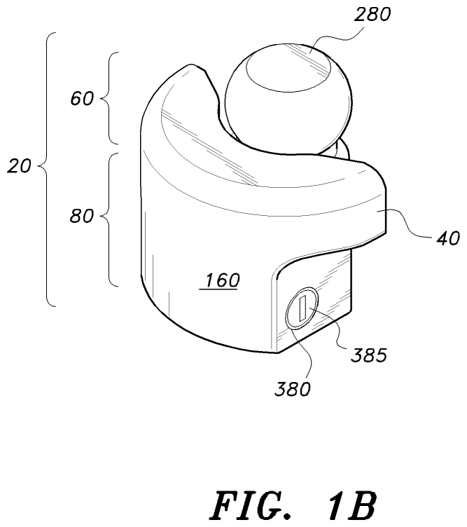

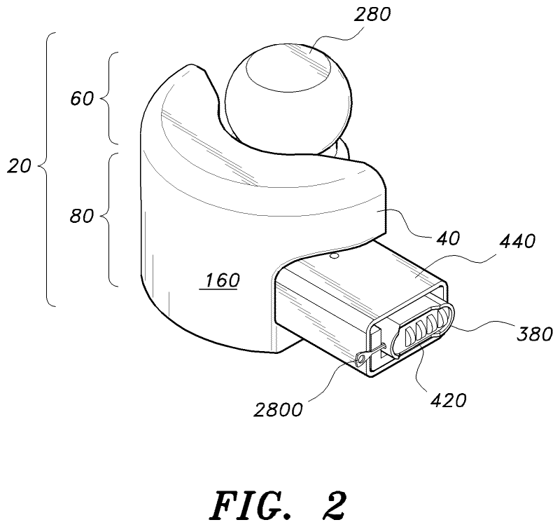

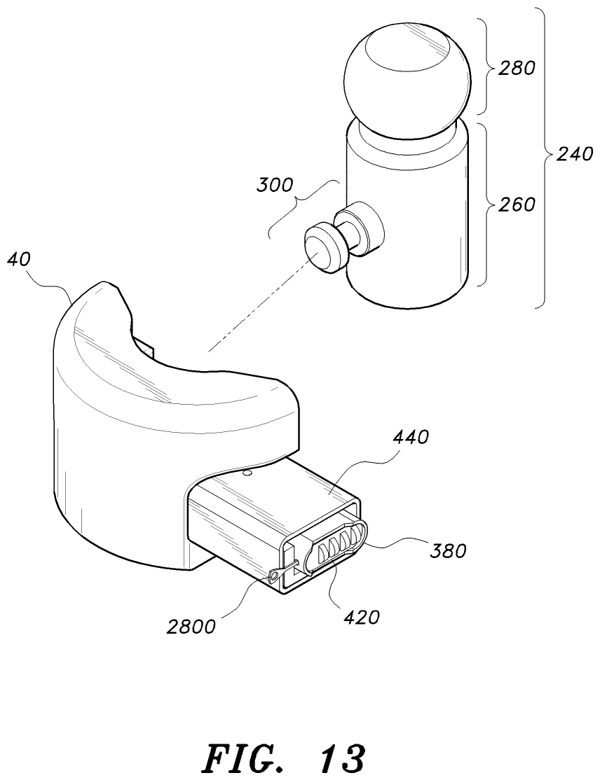

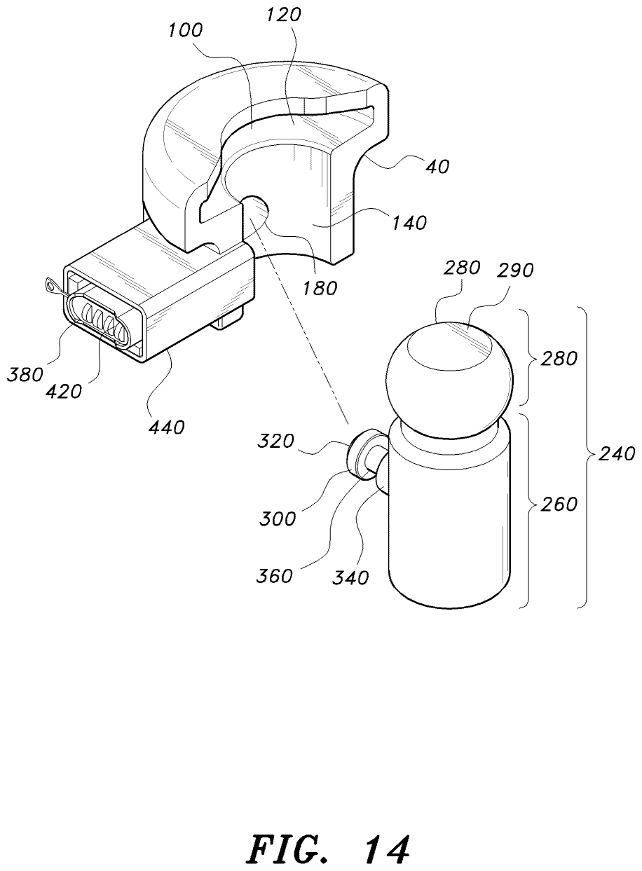

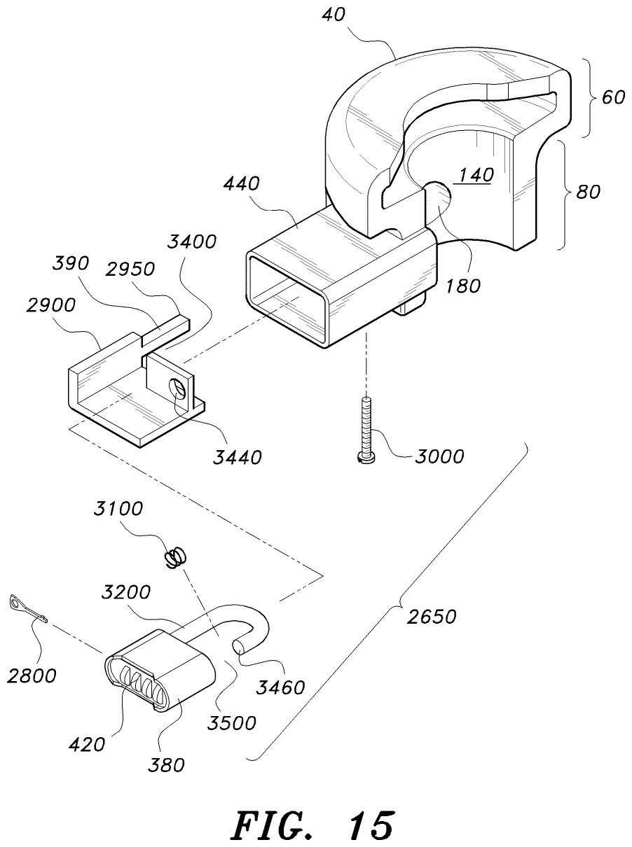

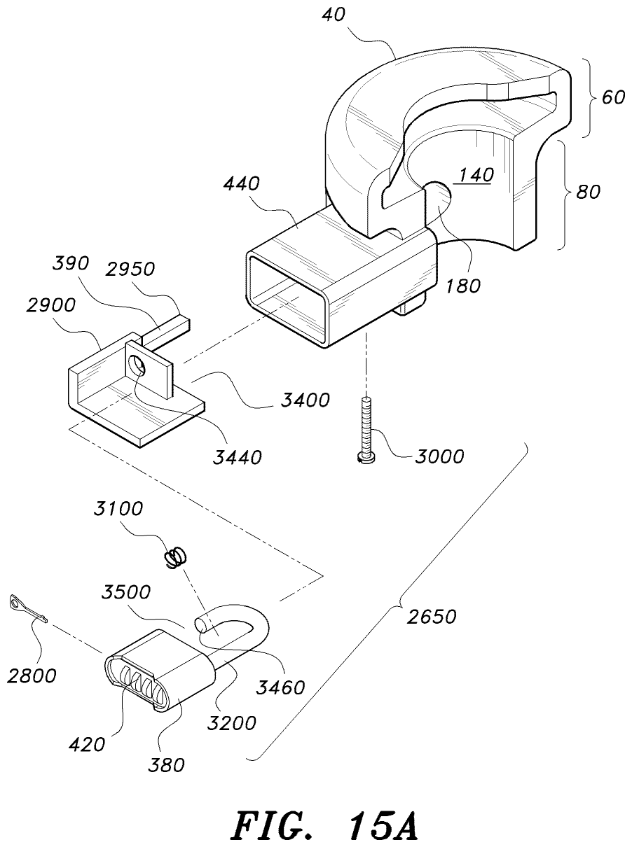

It should be understood that exact nature of the lock mechanism 380 can vary. In one non-limiting embodiment, the lock mechanism 380 is a barrel lock 385 as shown, for example, in FIGS. 1, 3, and 5. In an alternative non-limiting embodiment, the lock mechanism 380 can be a combination lock 420 as shown, for example, in FIGS. 2, 13, and 14. In one non-limiting embodiment, the lock mechanism 380 is interchangeable between a barrel lock 385 and a combination lock 420. In one non-limiting embodiment, the combination lock 420 is incorporated into a spring-loaded combination lock 2650 as shown in FIG. 15.

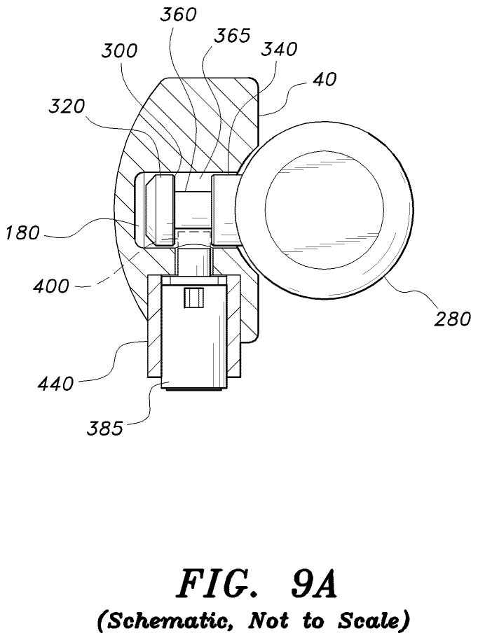

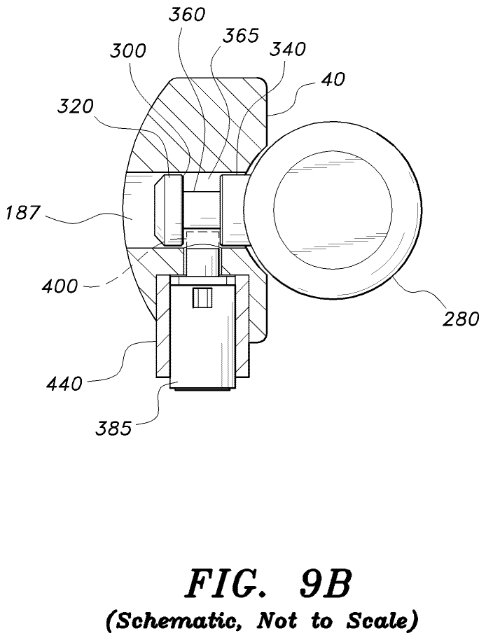

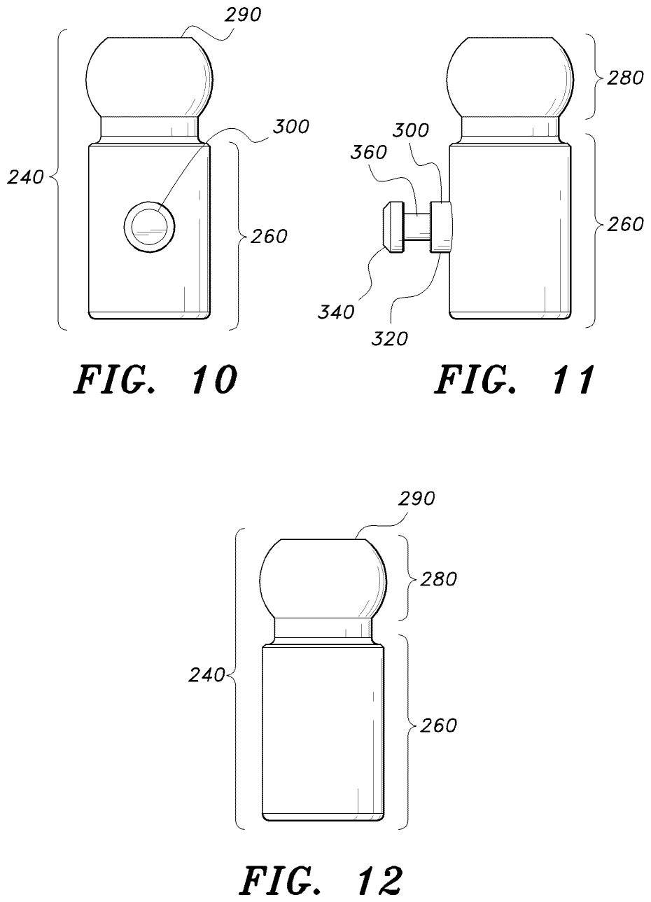

In one non-limiting embodiment, the barrel lock 385 comprises at least one locking component 390 (see, for example, FIG. 5), which can vary in nature. In one non-limiting embodiment the at least one locking component 390 is a bolt 400 as shown, for example, in FIGS. 5 and 9A. The bolt 400 extends and retracts in relation to the turn of a barrel lock key 410. In its extended state the bolt 400 is mechanically inserted into the notch 360 thereby securing the longitudinal male member 300 and hence the shaft 260 to which the longitudinal male member 300 is attached and thereby also necessarily securing the handle 240. In, for example, FIG. 9A a dashed line represents the bolt 400 in its extended position.

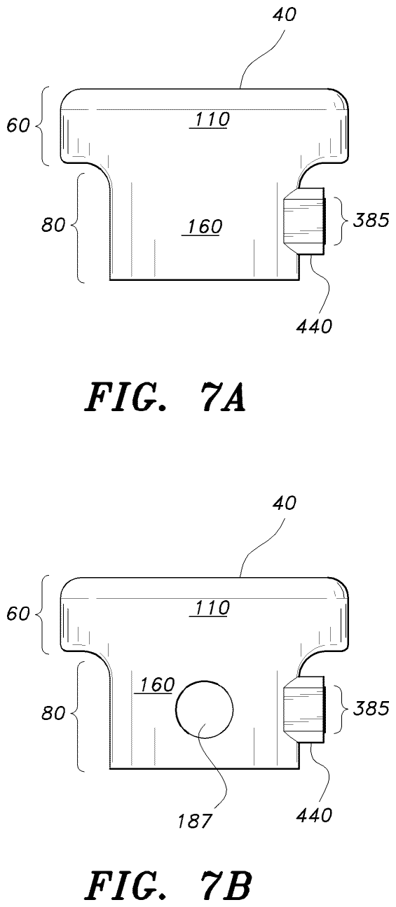

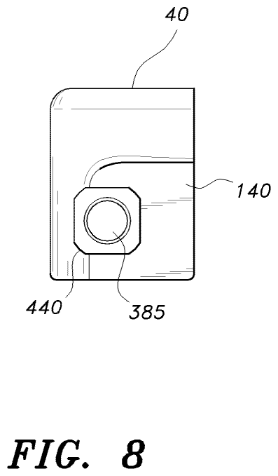

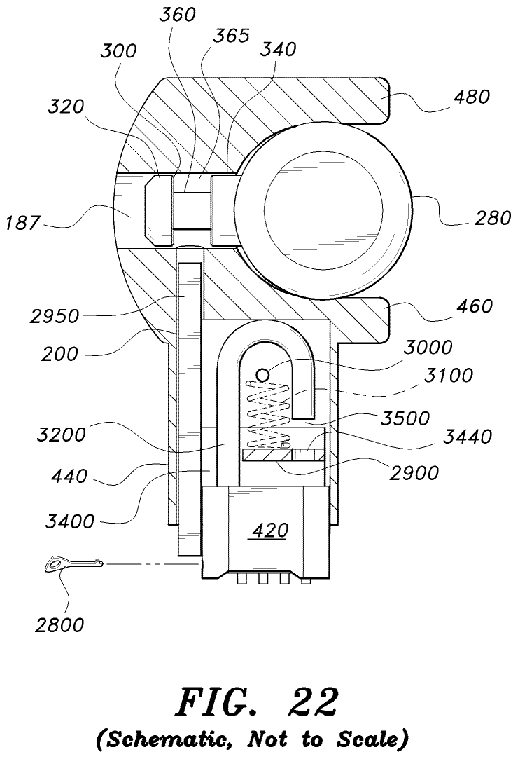

In one non-limiting embodiment, the female blind hole 180 is replaced with a female through-hole 187 (see FIGS. 7B and 9B). Specifically, the female through-hole 187 extends between the lower portion internal side 140 and the lower portion external side 160. It should be understood that the term “female” is used in the context of the longitudinal male member 300 with the first opposite end 320 thereof fits inside the female blind hole 180 (or in the case of the female through-hole 187, then the first opposite end 320 of the longitudinal male member 300 fits inside the female through-hole 187); also see FIG. 22. (The female through-hole 187 and the through-hole 200 are essentially perpendicular with respect to each other.)

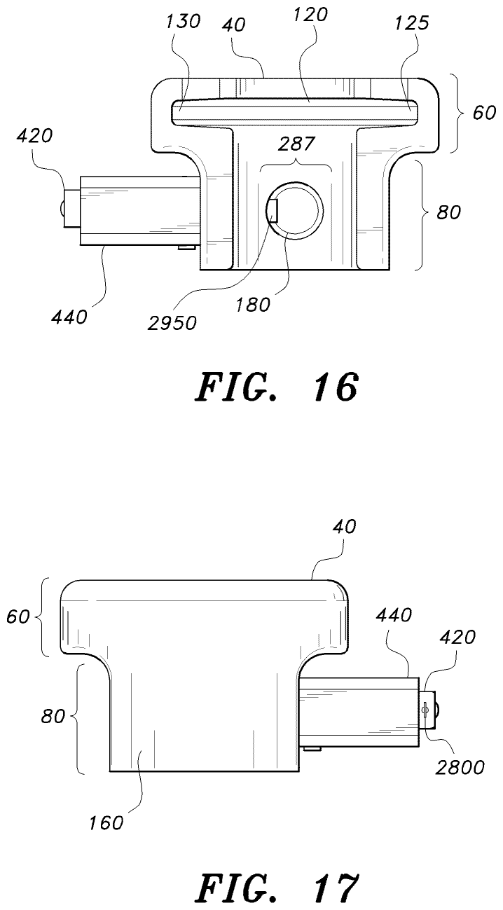

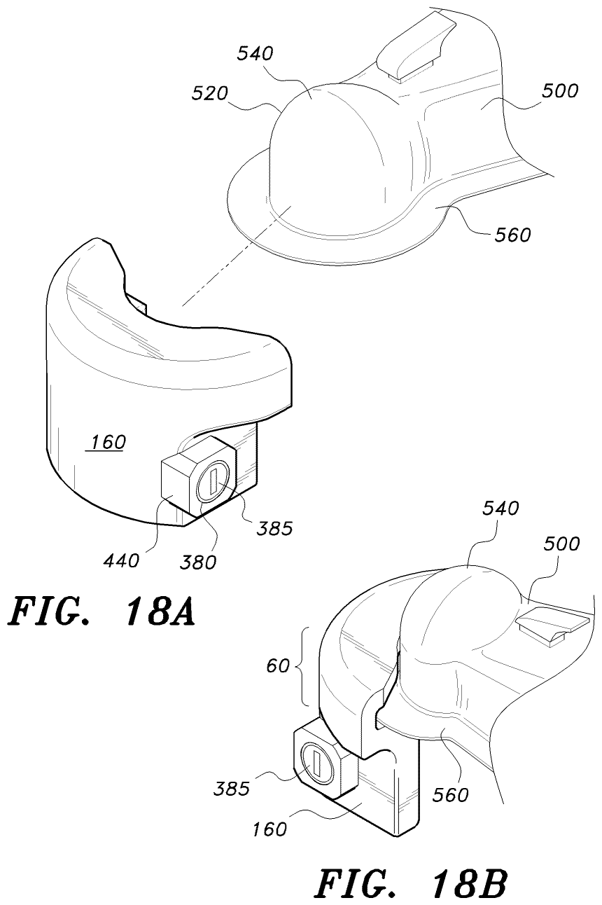

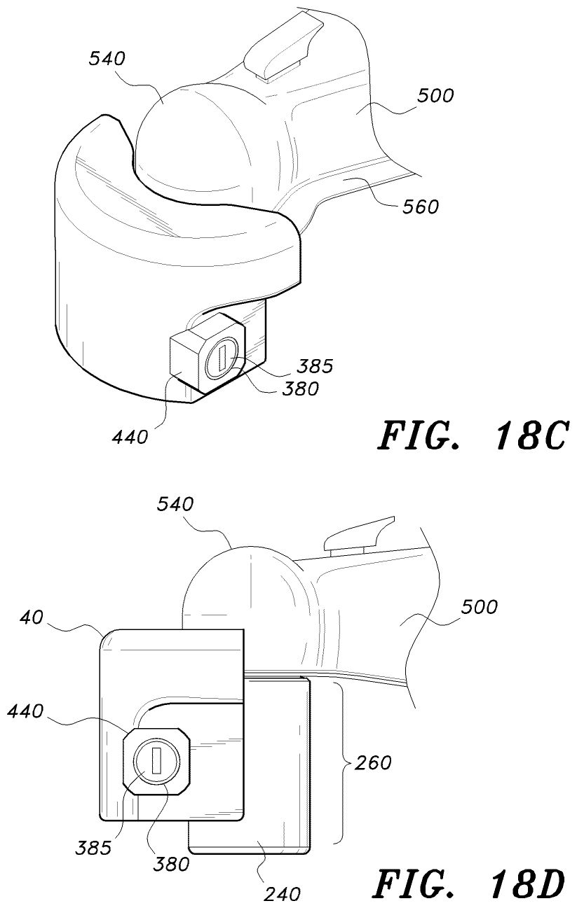

In normal use a trailer coupler 500 is docked to the upper portion 60 of the C-shaped member 40 as shown in environmental views FIGS. 18A, 18B, 18C, and 18D. Specifically, an end 520 of a trailer coupler 500 defines a hollow semi-spherical portion 540. A lip 560 extends at least partly around end 520 of the trailer coupler 500. The channel 120 is sized to accommodate at least a portion of the lip 560 (the channel 120 is show, for example, in FIGS. 4 and 6). The ball 280 of the handle 240 is inserted into the hollow semi-spherical portion 540 thereby securing the C-shaped member 40 of the anti-theft device 20 to the trailer coupler 500. While a barrel lock is shown in FIGS. 18A, 18B, 18C, and 18D, the depicted docking process also applies to the combination lock 420 for securing the trailer coupler to the anti-theft device 20 of the present invention.

In one non-limiting embodiment, the C-shaped member 40 is cast as a single piece, i.e., the upper portion (60) and said lower portion (80) are cast as a single piece. In another non-limiting embodiment, the C-shaped member 40 and the lock housing 440 are cast as a single piece. In one non-limiting embodiment, the shaft 260, ball 280, and longitudinal male member 300 are cast as a single piece. In one non-limiting embodiment, the shaft 260 and the ball 280 are cast as a single piece. In one non-limiting embodiment, the shaft 260 and the ball 280 are cast as two pieces and joined together.

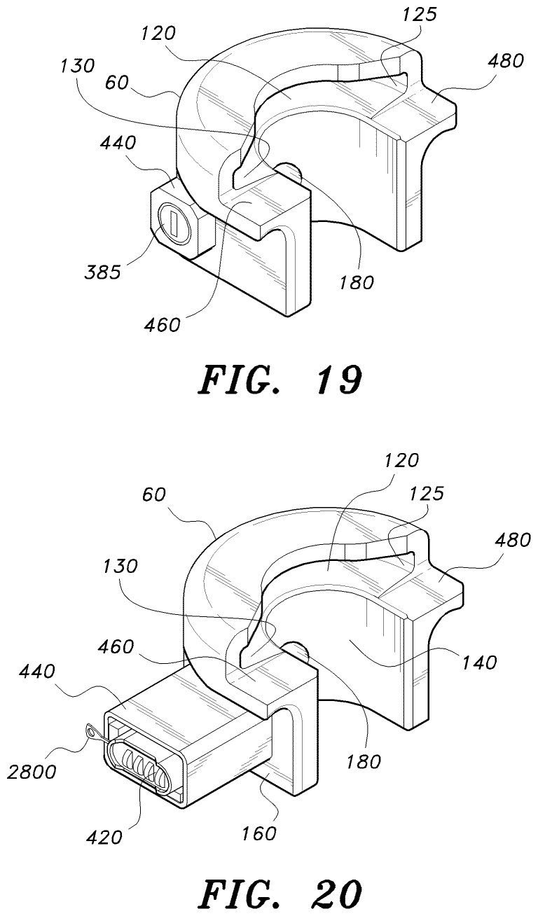

In a non-limiting embodiment, the anti-theft device 20 further comprises a first L-flange 460 and a second L-flange 480 as shown, for example, in FIGS. 19 and 20. The first L-flange 460 and the second L-flange 480 are located opposite each other and face away from each other as shown in FIGS. 19 and 20. The first 460 and the second 480 L-flanges respectively extend from first 125 and second 130 ends of the channel 120. The first and second L-flanges 460 and 480 serve to provide enhanced protection from illicit attempts of overcoming the anti-theft device 20.

As noted above, the combination lock 420 can be incorporated into a spring-loaded combination lock 2650 (see FIG. 15). An optional combination lock set key 2800 is also shown. If present, the optional combination lock set key 2800 is used to set the combination of the combination lock 420 when the combination lock 420 is in an open unlocked state. In, for example, FIG. 20, a lock housing 440 is shown located at least partly around the combination lock 420.

FIG. 15 shows an exploded view of the spring-loaded combination lock 2650. The spring-loaded combination lock 2650, which includes the combination lock 420, further comprises a lock bracket 2900 used to hold the combination lock 420. A bracket tongue 2950 extends from the lock bracket 2900. A securing member 3000 is used to secure the combination lock 420 in the housing 440. (With respect to the spring-loaded combination lock 2650, the at least one locking component 390 takes the form of a bracket tongue 2950.)

The lock bracket 2900 defines a lock bracket hole 3440. A combination lock hook 3200 fits through a lock bracket gap 3400. The lock bracket gap 3400 allows hook end 3460 of the combination lock hook 3200 to fit through the lock bracket hole 3440. The spring-loaded combination lock 2650 further comprises a spring 3100. The combination lock hook 3200 is shown in an unlocked configuration with hook gap 3500 visible. The spring 3100 is confined within the confines of the combination lock hook 3200.

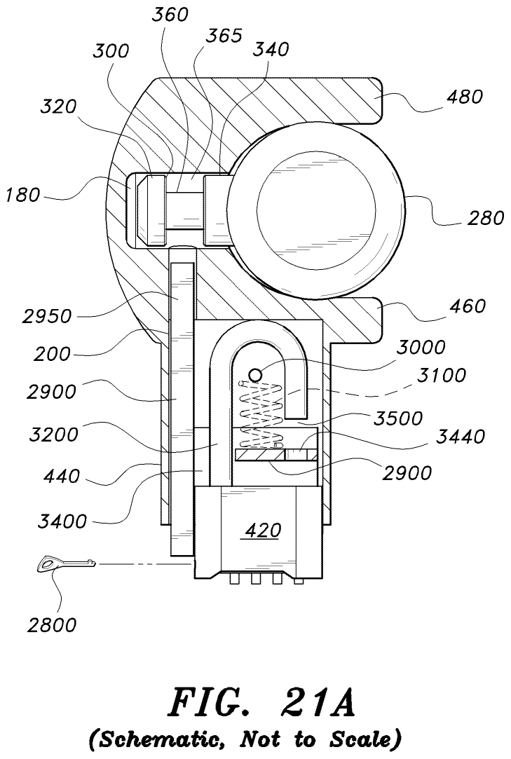

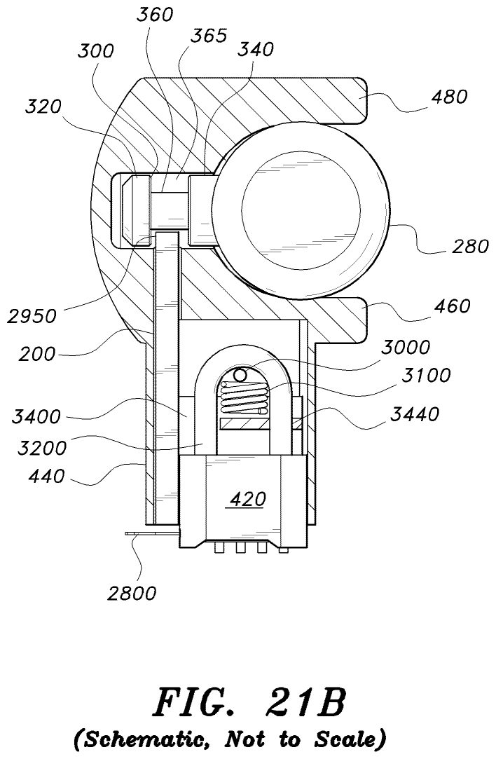

FIG. 21A shows a section view of the combination lock 420 with the combination lock 420 in its unlocked configuration. In this configuration the spring 3100 is decompressed having pushed the combination lock 420 partly out of housing 440. The combination lock hook 3200 is shown in an open state (revealing hook gap 3500). The bracket tongue 2950 is shown withdrawn from the notch 360 thereby releasing the male member 300, and consequently also releasing the shaft 280 and also necessarily the handle 240 of which the shaft 280 and male member 300 are parts thereof.

FIG. 21B shows a section view of the combination lock 420 in its locked configuration with the spring 3100 compressed. The bracket tongue 2950 is shown in operable communication with the notch 360 via through-hole 200. Hence the male member 300 is held in its locked position thereby also securing the shaft 260 and also necessarily the handle 240 of which the shaft 260 and male member 300 are parts thereof.

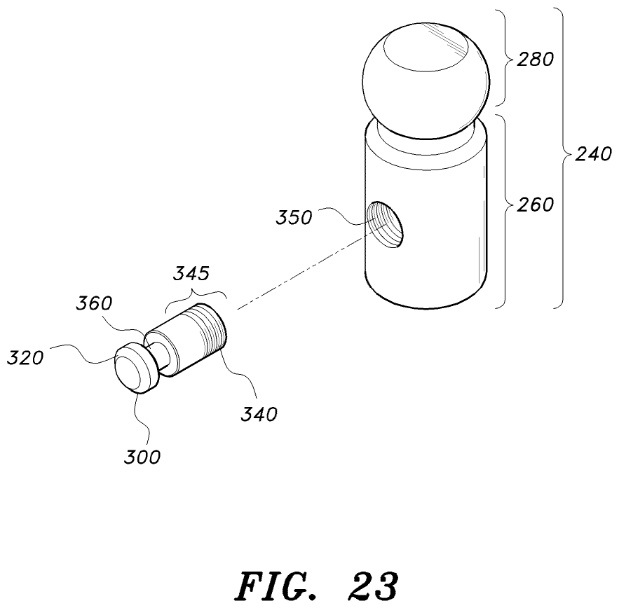

In one non-limiting embodiment, the second opposite end 340 of the longitudinal male member 300 defines a first threaded portion 345 to engage a complementary second threaded portion 350 located in the shaft 260 (see FIG. 23). In this non-limiting embodiment, these threads allow fine adjustments in the operation of the anti-theft device 20.

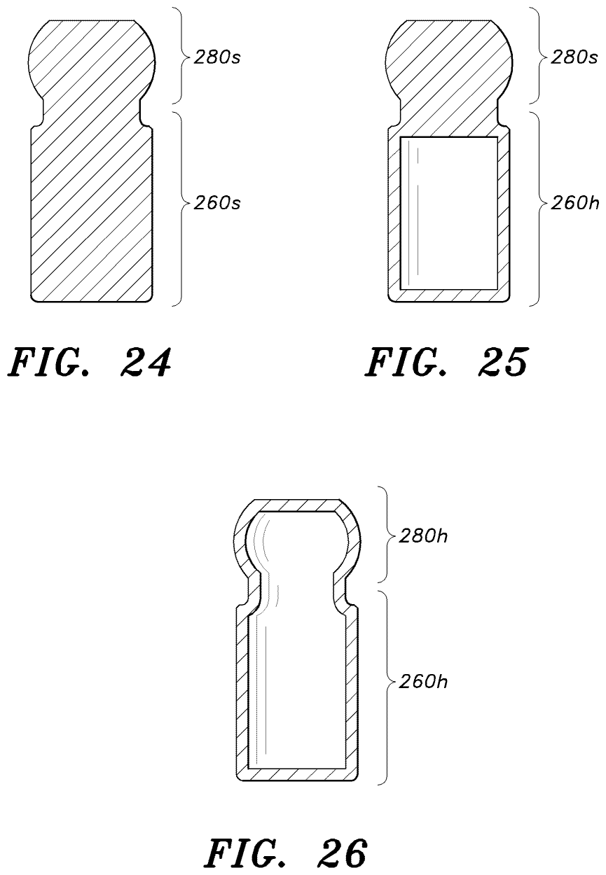

In one non-limiting embodiment, the shaft 260 of the handle 240 is solid and the ball 280 is solid as shown in FIG. 24. In one non-limiting embodiment, the shaft 260 of the handle 240 is hollow and the ball 280 is solid as shown in FIG. 25. In one non-limiting embodiment, the shaft 260 of the handle 240 is hollow and the ball 280 is also hollow as shown in FIG. 26. For convenience, solid is indicated as “s”; and hollow as “h”.

In one non-limiting embodiment, at least one of the C-shaped member 40, the handle 240, and the lock housing 440 is made of steel. In one non-limiting embodiment, at least one of the C-shaped member 40, the handle 240, and the lock housing 440 is made of stainless steel.

In one embodiment an anti-theft device 20 is provided, comprising: a C-shaped member 40, a handle 240, a lock mechanism 380, and a lock housing 440.

In one embodiment the anti-theft device 20 is provided, comprising: a C-shaped member 40, a handle 240, and a lock mechanism 380; in this embodiment a lock housing 440 is not required. For example, in FIGS. 1B and 5B the lock mechanism is a barrel lock which sits flush with external side 160. Thus, there is no intrinsic requirement for a lock housing 440.

The C-shaped member 40 defines an upper portion 60 and a lower portion 80. The upper portion 60 defines an upper portion internal side 100 and an upper portion external side 110. The upper portion internal side 100 defines a channel 120. The lower portion 80 defines a lower portion internal side 140 and a lower portion external side 160. The lower portion internal side 140 defines a female blind hole 180. A through-hole 200 extends between the lower portion internal side 140 and the lower portion external side 160. The female blind hole 180 is located in a central portion 220 of the lower portion internal side 140.

The handle 240 comprises a shaft 260 and a ball 280. The ball 280 is located atop of the shaft 260. The shaft 260 comprises a longitudinal male member 300 extending away essentially at a perpendicular angle from the shaft 260. The longitudinal male member 300 defines a first opposite end 320 and a second opposite end 340. The first opposite end 320 is sized to fit inside the female blind hole 180. The second opposite end 340 is attached to the shaft 260. The longitudinal male member 300 defines a notch 360.

The lock mechanism 380 is in operable communication with the notch 360 via the through-hole 200.

The lock housing 440 is located at least partly around the lock mechanism 380.

In another embodiment, an anti-theft device 20 is provided, comprising a C-shaped member 40, a handle 240, a lock mechanism 380, and a lock housing 440.

The C-shaped member 40 defines an upper portion 60 and a lower portion 80. The upper portion 60 defines an upper portion internal side 100 and an upper portion external side 110. The upper portion internal side 100 defines a channel 120. The lower portion 80 defines a lower portion internal side 140 and a lower portion external side 160. The lower portion internal side 140 defines a female through-hole 187. The female through-hole 187 extends between the lower portion internal side 140 and the lower portion external side 160. A through-hole 200 extends between the lower portion internal side 140 and the lower portion external side 160. The female through-hole 187 and the through-hole 200 are essentially perpendicular with respect to each other.

The handle 240 comprises a shaft 260 and a ball 280. The ball 280 is located atop of the shaft 260. The shaft 260 comprises a longitudinal male member 300 extending away essentially at a perpendicular angle from the shaft 260. The longitudinal male member 300 defines a first opposite end 320 and a second opposite end 340. The first opposite end 320 is sized to fit inside the female through-hole 187. The second opposite end 340 is attached to the shaft 260. The longitudinal male member 300 defines a notch 360.

The lock mechanism 380 is in operable communication with the notch 360 via the through-hole 200.

The lock housing 440 is located at least partly around the lock mechanism 380.

In a further embodiment an anti-theft device 20 is provided, comprising a C-shaped member 40, a handle 240, a lock mechanism 380, a lock housing 440, a first L-flange 460, and a second L-flange 480.

The C-shaped member 40 defines an upper portion 60 and a lower portion 80. The upper portion 60 defines an upper portion internal side 100 and an upper portion external side 110. The upper portion internal side 100 defines a channel 120. The channel 120 defines a first end 125 and a second end 130. The lower portion 80 defines a lower portion internal side 140 and a lower portion external side 160. The lower portion internal side 140 defines a female blind hole 180. A through-hole 200 extends between the lower portion internal side 140 and the lower portion external side 160. The female blind hole 180 being located in a central portion 220 of the lower portion internal side 140.

The handle 240 comprises a shaft 260 and a ball 280. The ball 280 is located atop of the shaft 260. The shaft 260 comprises a longitudinal male member 300 extending away essentially at a perpendicular angle from the shaft 260. The longitudinal male member 300 defines a first opposite end 320 and a second opposite end 340. The first opposite end 320 is sized to fit inside the female blind hole 180. The second opposite end 340 is attached to the shaft 260. The longitudinal male member 300 defines a circumferential groove 365.

The lock mechanism 380 is in operable communication with the circumferential groove 365 via said through-hole 200.

The lock housing 440 is located at least partly around the lock mechanism 380.

The first L-flange 460 and the second L-flange 480 are located opposite each other and face away from each other. The first 460 and the second 480 L-flanges respectively extend from the first 125 and the second 130 ends of the channel 120.

In one non-limiting embodiment, at least one of said C-shaped member 40, said handle 240, said lock housing 440, said first L-flange 460, and said second L-flange 480 is made of steel. In one non-limiting embodiment, at least one of said C-shaped member 40, said handle 240, said lock housing 440, said first L-flange 460, and said second L-flange 480 is made of stainless steel.

It is to be understood that the present invention is not limited to the embodiments described above, but encompasses any and all embodiments within the scope of the following claims.

1. An anti-theft device (20), comprising:
a C-shaped member (40), wherein said C-shaped member (40) defines an upper portion (60) and a lower portion (80),
wherein said upper portion (60) defines an upper portion internal side (100) and an upper portion external side (110), said upper portion internal side (100) defines a channel (120),
wherein said lower portion (80) defines a lower portion internal side (140) and a lower portion external side (160), said lower portion internal side (140) defines a female blind hole (180), wherein a through-hole (200) extends between said lower portion internal side (140) and said lower portion external side (160), said female blind hole (180) being located in a central portion (220) of said lower portion internal side (140),
wherein said upper portion (60) and said lower portion (80) are cast as a single piece;
a handle (240) comprising a shaft (260) and a ball (280), said ball (280) is located atop of said shaft (260), said shaft (260) comprises a longitudinal male member (300) extending away essentially at a perpendicular angle from said shaft (260), said longitudinal male member (300) defines a first opposite end (320) and a second opposite end (340), said first opposite end (320) is sized to fit inside said female blind hole (180), said second opposite end (340) is attached to said shaft (260), said longitudinal male member (300) defines a notch (360); and
a lock mechanism (380) in operable communication with said notch (360) via said through-hole (200).

2. The anti-theft device (20) of claim 1, wherein said notch (360) defines a circumferential groove (365).

3. The anti-theft device (20) of claim 1, wherein a trailer coupler (500) defines an end (520) of said trailer coupler (500), said end (520) defines a hollow semi-spherical portion (540) which sits on said ball (280) of said handle (240), wherein a lip (560) extends around said hollow semi-spherical portion (540), and wherein said channel (120) is sized to accommodate at least a portion of said lip (560).

4. The anti-theft device (20) of claim 1, wherein said lock mechanism (380) is a barrel lock (385).

5. The anti-theft device (20) of claim 1, wherein said lock mechanism (380) is a combination lock (420).

6. The anti-theft device (20) of claim 1, wherein said lock mechanism (380) is a combination lock (420), wherein said combination lock (420) is incorporated into a spring-loaded combination lock (2650).

7. The anti-theft device (20) of claim 1, wherein said lock mechanism (380) is interchangeable between a barrel lock (385) and a combination lock (420).

8. The anti-theft device (20) of claim 1, wherein said shaft (260) of said handle (240) is solid and said ball (280) is solid.

9. The anti-theft device (20) of claim 1, wherein said shaft (260) of said handle (240) is hollow and said ball (280) is solid.

10. The anti-theft device (20) of claim 1, wherein said shaft (260) of said handle (240) is hollow and said ball (280) is hollow.

11. The anti-theft device (20) of claim 1, wherein said second opposite (340) end of said longitudinal male member (300) defines a first threaded portion (345) to engage a complementary second threaded portion (350) located in said shaft (260).

12. The anti-theft device (20) of claim 1, wherein at least one of said C-shaped member (40), and said handle (240) is made of steel.

13. The anti-theft device (20) of claim 1, wherein at least one of said C-shaped member (40), and said handle (240) is made of stainless steel.

14. The anti-theft device (20) of claim 1, wherein said shaft (260) including said longitudinal male member (300), and said ball (280) are cast as a single piece.

15. An anti-theft device (20), comprising:
a C-shaped member (40), wherein said C-shaped member (40) defines an upper portion (60) and a lower portion (80),
wherein said upper portion (60) defines an upper portion internal side (100) and an upper portion external side (110), said upper portion internal side (100) defines a channel (120),
wherein said lower portion (80) defines a lower portion internal side (140) and a lower portion external side (160), said lower portion internal side (140) defines a female through-hole (187), wherein said female through-hole (187) extends between said lower portion internal side (140) and said lower portion external side (160), wherein a through-hole (200) extends between said lower portion internal side (140) and said lower portion external side (160), wherein said female through-hole (187) and said through-hole (200) are essentially perpendicular with respect to each other;
a handle (240) comprising a shaft (260) and a ball (280), said ball (280) is located atop of said shaft (260), said shaft (260) comprises a longitudinal male member (300) extending away essentially at a perpendicular angle from said shaft (260), said longitudinal male member (300) defines a first opposite end (320) and a second opposite end (340), said first opposite end (320) is sized to fit inside said female through-hole (187), said second opposite end (340) is attached to said shaft (260), said longitudinal male member (300) defines a circumferential groove (365);
a lock mechanism (380) in operable communication with said circumferential groove (365) via said through-hole (200); and
a lock housing (440), wherein said lock housing (440) is located at least partly around said lock mechanism (380),
wherein said upper portion (60), said lower portion (80), and said lock housing (440) are cast as a single piece.

16. An anti-theft device (20), comprising:
a C-shaped member (40), wherein said C-shaped member (40) defines an upper portion (60) and a lower portion (80),
wherein said upper portion (60) defines an upper portion internal side (100) and an upper portion external side (110), said upper portion internal side (100) defines a channel (120), wherein said channel (120) defines a first end (125) and a second end (130),
wherein said lower portion (80) defines a lower portion internal side (140) and a lower portion external side (160), said lower portion internal side (140) defines a female blind hole (180), wherein a through-hole (200) extends between said lower portion internal side (140) and said lower portion external side (160), said female blind hole (180) being located in a central portion (220) of said lower portion internal side (140);
a handle (240) comprising a shaft (260) and a ball (280), said ball (280) is located atop of said shaft (260), said shaft (260) comprises a longitudinal male member (300) extending away essentially at a perpendicular angle from said shaft (260), said longitudinal male member (300) defines a first opposite end (320) and a second opposite end (340), said first opposite end (320) is sized to fit inside said female blind hole (180), said second opposite end (340) is attached to said shaft (260), said longitudinal male member (300) defines a circumferential groove (365);
a lock mechanism (380) in operable communication with said circumferential groove

(365) via said through-hole (200);
a lock housing (440), wherein said lock housing (440) is located at least partly around said lock mechanism (380); and
a first L-flange (460) and a second L-flange (480), wherein said first L-flange (460) and said second L-flange (480) are located opposite each other and face away from each other, said first (460) and said second (480) L-flanges respectively extend from said first (125) and said second (130) ends of said channel (120).

17. The anti-theft device (20) of claim 16, wherein said lock mechanism (380) is a barrel lock (385).

18. The anti-theft device (20) of claim 16, wherein said lock mechanism (380) is a combination lock (420).

19. The anti-theft device (20) of claim 16, wherein said lock mechanism (380) is a combination lock (420), wherein said combination lock (420) is incorporated into a spring-loaded combination lock (2650).

20. The anti-theft device (20) of claim 16, wherein at least one of said C-shaped member (40), said handle (240), said lock housing (440), said first L-flange (460), and said second L-flange (480) is made of steel.

21. The anti-theft device (20) of claim 16, wherein at least one of said C-shaped member (40), said handle (240), said lock housing (440), said first L-flange (460), and said second L-flange (480) is made of stainless steel.

22. The anti-theft device (20) of claim 16, wherein a trailer coupler (500) defines an end (520) of said trailer coupler (500), said end (520) defines a hollow semi-spherical portion (540) which sits on said ball (280) of said handle (240), wherein a lip (560) extends around said hollow semi-spherical portion (540), and wherein said channel (120) is sized to accommodate at least a portion of said lip (560).

23. The anti-theft device (20) of claim 16, wherein said upper portion (60) and said lower portion (80), said lock housing (440), said first L-flange (460), and said second L-flange (480) are cast as a single piece.
